(19) United States
(12) Patent Application Publication
(10) Pub. No.: US 2021/0307361 A1
(43) Pub. Date: Oct. 7, 2021

(54) Compositions and Methods for Feeding Domesticated Animals

(71) Applicant: Locus IP Company, LLC, Solon, OH (US)

(72) Inventors: Sean FARMER, Ft. Lauderdale, FL (US); Ken ALIBEK, Solon, OH (US)

(21) Appl. No.: 17/264,829

(22) PCT Filed: Sep. 26, 2019
(86) PCT No.: PCT/US2019/053212

§ 371 Date: Jan. 31, 2021

Related U.S. Application Data
(60) Provisional application No. 62/738,462, filed on Sep. 28, 2018.

(51) Int. Cl. A23K 20/158; A23K 10/18; A23K 10/12

(52) U.S. Cl. CPC A23K 20/158; A23K 10/12; A23K 10/18

(57) ABSTRACT

The subject invention provides methods and compositions for feeding domesticated animals. In certain embodiments, compositions comprising a microorganism and/or a microbial growth by-products is contacted with an animal's food and/or drinking water. Preferably, the growth by-product is a biosurfactant. Advantageously, the subject invention can promote good health and well-being in a domesticated animal by, for example, enhancing the animal's immune system, promoting digestive health, providing nutrients to the animal and promoting dental/oral cavity health. Furthermore, the subject invention can be used to prolong the shelf life of pet food and prevent contamination of food from deleterious microorganisms.

### CROSS-REFERENCE TO RELATED APPLICATION

This application claims priority to U.S. Provisional Patent App. No. 62/738,462, filed Sep. 28, 2018, which is incorporated herein by reference in its entirety.

### BACKGROUND OF THE INVENTION

When raising domesticated animals, whether for livestock or companionship, the health and well-being of an animal depends largely upon its diet. While pets have varying nutritional needs, depending on, for example, their species, breed, size, age, and health status, a pet's diet must supply basic necessary nutrients, must be palatable to the animal, and must be readily digestible so that the animal can reap the maximum health benefits from the food.

Food for domesticated animals such as dogs and cats is typically produced at a food manufacturing facility, and subsequently packaged and distributed to the animal owner through various wholesale and retail distribution channels. The food types may include, for example, dry kibble, wet food, semi-moist food, frozen food, freeze-dried food, biscuits, cakes or treats.

Ideal pet food must contain digestible protein sources along with a full range of other bioavailable components, which can include amino acids, carbohydrates, vitamins, minerals, and essential fatty acids. With dry foods, however, many of these nutrients are found in less than optimal amounts due to the extrusion processes used to produce kibbles and pellets. A mixture of raw dry and wet ingredients are mixed to form a dough, which is cooked under extreme pressure and high temperature. The dough is then forced, or extruded, through specially-shaped holes to form the pellets. The high heat applied during extrusion can cause thermal degradation of many valuable nutrients in the final food product.

Furthermore, for many types of pet food, the formulations necessarily contain preservatives to prolong the food's shelf life and prevent contamination. Without preservation, pet food quickly spoils and can produce illness if consumed. There are many ways to preserve commercially prepared dog food, many of which include the use of artificial preservative compounds, such as, for example, butylated hydroxyanisole (BHA), butylated hydroxytoluene (BHT), ethoxyquin, propylene glycol, tertiary butylhydroquinone (TBHQ), and sodium metabisulphite—many of which have been linked to cancer.

Pets can be afflicted with many of the same common ailments that afflict humans, including, for example, infections, digestive issues, nutrient deficiencies, dental/oral health pathologies, and inflammation. Consumption of highly processed foods with excess calories, low nutrient content, and chemical preservatives can contribute to these health problems, as well as to obesity, arthritis, diabetes and cancer.

Many of these ailments can be resolved, either indirectly or directly, through a well-balanced diet. Thus, improved compositions are needed for feeding pets and other domesticated animals.

### BRIEF SUMMARY OF THE INVENTION

The subject invention relates to the use of microorganisms and/or their growth by-products in feeding domesticated animals, such as, for example, dogs, cats, and livestock. Advantageously, the compositions and methods of the subject invention can provide a number of benefits, including, for example, increasing the bioavailability and absorption of nutrients through an animal's gastrointestinal (GI) tract, enhancing digestive health, preventing and/or controlling infections of the GI tract and/or the oral cavity, enhancing dental health, and preventing spoilage and/or contamination of pet food. Furthermore, the subject compositions are naturally-derived, environmentally-friendly, and do not negatively alter the palatability of pet food.

In preferred embodiments, the subject invention provides a composition for feeding domesticated animals, the composition comprising one or more beneficial microorganisms and/or one or more microbial growth by-products. If present, the microorganisms in the composition may be in an active or inactive form. In some embodiments, the microorganisms are separated from the growth by-product. In preferred embodiments, the beneficial microorganisms are non-pathogenic fungi, yeasts and/or bacteria.

In one embodiment, the composition comprises one or more yeasts and/or one or more growth by-products thereof. The yeast(s) can be, for example, Wickerhamomyces anomalus, Saccharomyces spp. (e.g., S. cerevisiae and/or S. boulardii), Starmerella bombicola, Meyerozyma guilliermondii, Pichia occidentalis, Monascus purpureus, and/or Acremonium chrysogenum. The yeast(s) can be in the form of live or inactive cells or spores, as well as in the form of a dried cell mass and/or dormant cells (e.g., a yeast hydrolysate).

In certain embodiments, the composition comprises one or more fungi and/or one or more growth by-products thereof. The fungi can be, for example, Pleurotus spp. fungi, e.g., P. ostreatus (oyster mushrooms), Lentinula spp. fungi, e.g., L. edodes (shiitake mushrooms), and/or Trichoderma spp. fungi, e.g., T. viride. The fungi can be in the form of live or inactive cells, mycelia, spores and/or fruiting bodies. The fruiting bodies, if present, can be, for example, chopped and/or blended into granules and/or a powder form.

In one embodiment, the composition comprises one or more additional beneficial microorganisms, for example, one or more Bacillus spp. bacteria. In certain embodiments, the Bacillus spp. are B. amyloliquefaciens, B. subtilis and/or B. licheniformis.

In preferred embodiments, the microbe-based composition comprises microbial growth by-products. The composition can comprise the fermentation medium in which the microorganism and/or the growth by-product were produced.

In one embodiment, the growth by-product has been purified from the fermentation medium in which it was produced. Alternatively, in one embodiment, the growth by-product is utilized in crude form. The crude form can take the form of, for example, a liquid supernatant resulting from cultivation of a microbe that produces the growth by-product of interest.

The growth by-products can also include metabolites or other biochemicals produced as a result of cell growth, including, for example, amino acids, peptides, proteins, enzymes, solvents and/or other metabolites.

In certain embodiments, the biosurfactant can be added to the composition in the form of a microbial culture containing liquid fermentation broth and cells resulting from submerged cultivation of a biosurfactant-producing microbe. In a specific embodiment, when the biosurfactant is a sophorolipid, this “culture form” biosurfactant can comprise fermentation broth with Starmerella bombicola yeast cells, sophorolipids, and other yeast growth by-products therein. The yeast cells may be active or inactive at the time they are contacted with or formulated with pet food. If a lower concentration of sophorolipids is desired, the sophorolipid portion that results in the S. bombicola culture can be removed, and the residual liquid having, for example, 1-4 g/L residual sophorolipids and, optionally, yeast cells and other growth by-products can be utilized in the subject methods. When use of another biosurfactant is desired, a similar product is envisioned that utilizes any other microbe capable of producing the other biosurfactant.

In one embodiment, the subject composition can comprise one or more substances and/or nutrients to supplement animal food and promote health and/or well-being in an animal, such as, for example, sources of amino acids (including essential amino acids), peptides, proteins, vitamins, microelements, fats, fatty acids, lipids, carbohydrates, sterols, enzymes, and trace minerals such as, iron, copper, zinc, manganese, cobalt, iodine, selenium, molybdenum, nickel, fluorine, vanadium, tin and silicon. In some embodiments, the microorganisms of the composition produce and/or provide these substances.

In one embodiment, the composition comprises one or more sources of prebiotics, such as kelp extract, hay, alfalfa, straw, silage, grains and/or legumes.

In certain embodiments, the compositions according to the subject invention can be superior to, for example, purified microbial metabolites alone, due to, for example, the advantageous properties of the yeast cell walls. These properties include high concentrations of mannoprotein and the biopolymer beta-glucan as a part of a yeast cell wall's outer surface. These compounds can serve as, for example, effective emulsifiers. Additionally, the composition can further comprise residual biosurfactants in the culture, as well as other metabolites and/or cellular components, such as solvents, acids, vitamins, minerals, enzymes and proteins. Thus, the compositions can, among many other uses, act as a surface-active agent and can have antimicrobial and/or surface/interfacial tension-reducing properties.

In preferred embodiments, the subject invention provides a method for feeding domesticated animals, wherein a composition comprising a microorganism and/or a growth by-product thereof is contacted with an animal's food and/or drinking water, prior to the animal ingesting the food and/or water. Advantageously, the methods can be useful for providing a nutrient to an animal, as well as for enhancing the digestive (GI), dental, and immune health of an animal.

In one embodiment, the composition is used either as a liquid or a dried product. In one embodiment the composition is introduced, either in the liquid or dried form, into an animal's food, or into the animal's drinking water. In one embodiment, the composition is added to a chew toy or bone.

In one embodiment, the composition is added to standard raw pet foods, and/or to raw food ingredients utilized in producing cooked wet and/or dry pet food. Advantageously, this can prolong the shelf life of the pet food, as well as prevent contamination of the pet food by undesirable microorganisms.

In one embodiment, the composition is added to the ingredients utilized in producing, for example, dry kibbles, treats, biscuits, or pellets. The supplemented kibble can comprise consistent concentrations of the microbe-based composition per piece. In another embodiment, the composition can be utilized as a surface coating on the pieces. Methods known in the art for producing dried kibbles can be used. In certain preferred embodiments, a “cold” pelleting process is used, or a process that does not use high heat or steam.

Advantageously, due to the presence of, for example, biosurfactants in the composition, the methods can enhance nutrient absorption through the epithelial cells of the animal's digestive tract. Additionally, due to the antimicrobial properties of the composition, the methods can enhance the immune health of an animal, reduce the need for antibiotics, reduce GI infections, and reduce the occurrence of dental/oral conditions, such as halitosis, tooth decay and periodontal disease. Furthermore, the subject methods can help prolong the shelf life of pet food and/or prevent contamination by undesirable microorganisms, without the need for harmful chemical preservatives.

### DETAILED DESCRIPTION OF THE INVENTION

The subject invention provides compositions and methods for feeding domesticated animals, such as, for example, dogs, cats, and livestock. Advantageously, the compositions and methods of the subject invention can provide a number of benefits, including, for example, increasing the bioavailability and absorption of nutrients through an animal's gastrointestinal (GI) tract, enhancing digestive health, preventing and/or controlling infections of the GI tract and/or the oral cavity, enhancing dental health, and preventing spoilage and/or contamination of pet food. Furthermore, the subject invention utilizes compositions that are naturally-derived, environmentally-friendly, and do not negatively alter the palatability of pet food.

### Selected Definitions

As used herein, a “biofilm” is a complex aggregate of microorganisms, such as bacteria, wherein the cells adhere to each other and/or to a surface via an extracellular polysaccharide matrix. The cells in biofilms are physiologically distinct from planktonic cells of the same organism, which are single cells that can float or swim in liquid medium.

As used herein, the term “control” used in reference to a pest or other undesirable organism extends to the act of killing, disabling or immobilizing the pest or other organism, or otherwise rendering the pest or other organism substantially incapable of causing harm.

As used herein, a “domesticated” animal is an animal of a species that has been influenced, bred, tamed, and/or controlled over a sustained number of generations by humans, such that a mutualistic relationship exists between the animal and the human. Domesticated animals can be “pets,” which include animals that are raised and cared for by a human for protection and/or companionship, such as, for example, dogs, cats, horses, pigs, monkeys, birds, rodents and other small mammals, and reptiles. Domesticated animals can also be “livestock,” which include animals raised in an agricultural or industrial setting to produce commodities such as food, fiber and labor. Types of animals included in the term livestock can include, but are not limited to, alpacas, llamas, beef and dairy cattle, bison, pigs, sheep, goats, horses, mules, asses, camels, chickens, turkeys, ducks, geese, guinea fowl, and squabs.

As used herein, “harvested” in the context of microbial fermentation refers to removing some or all of a microbe-based composition from a growth vessel.

As used herein, an “isolated” or “purified” nucleic acid molecule, polynucleotide, polypeptide, protein, organic compound such as a small molecule (e.g., those described below), or other compound is substantially free of other compounds, such as cellular material, with which it is associated in nature. For example, a purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. A purified or isolated microbial strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites can include, but are not limited to, enzymes, toxins, acids, solvents, alcohols, proteins, carbohydrates, vitamins, minerals, microelements, amino acids, polymers, and surfactants.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of microbial propagule, or a mixture of these. The microbes may be planktonic or in a biofilm form, or a mixture of both. The by-products of growth may be, for example, metabolites (e.g., biosurfactants), cell membrane components, expressed proteins, and/or other cellular components. The microbes may be intact or lysed. The cells may be totally absent, or present at, for example, a concentration of at least 1×10⁴, 1×10⁵, 1×10⁶, 1×10⁷, 1×10⁸, 1×10⁹, 1×10¹⁰, 1×10¹¹, 1×10¹², 1×10¹³ or more CFU/ml of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, carriers (e.g., water or salt solutions), added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “preventing” a situation or occurrence, means delaying the onset or progression thereof through application of one or more preventative measures. In some instances, prevention may not be absolute, meaning that the situation or occurrence still may occur, but with delay and/or with less severity than it would without the preventative measures.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduction” means a negative alteration and “increase” means a positive alteration, wherein the positive or negative alteration is at least 0.25%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates embodiments “consisting” and “consisting essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Microbe-Based Compositions

In preferred embodiments, the subject invention provides a composition for feeding domesticated animals, the composition comprising a microorganism and/or a microbial growth by-product. If present, the microorganisms in the composition may be in an active or inactive form. In some embodiments, the microorganisms are separated from their growth by-products after cultivation.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

The beneficial microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the beneficial microorganisms are yeasts and/or fungi. Yeast and fungus species suitable for use according to the current invention, include Acaulospora, Acremonium chrysogenum, Aspergillus, Aureobasidium (e.g., A. pullulans), Blakeslea, Candida (e.g., C. albicans, C. apicola, C. batistae, C. bombicola, C. floricola, C. kuoi, C. riodocensis, C. nodaensis, C. stellate), Cryptococcus, Debaryomyces (e.g., D. hansenii), Entomophthora, Hanseniaspora (e.g., H. uvarum), Hansenula, Issatchenkia, Kluyveromyces (e.g., K. phaffii), Lentinula spp. (e.g., L. edodes), Meyerozyma (e.g., M. guilliermondii), Monascus purpureus, Mortierella, Mucor (e.g., M. piriformis), Penicillium, Phythium, Phycomyces, Pichia (e.g., P. anomala, P. guilliermondii, P. occidentalis, P. kudriavzevii, Pleurotus (e.g., P. ostreatus P. ostreatus, P. sajorcaju, P. cystidiosus, P. cornucopiae, P. pulmonarius, P. tuberregium, P. citrinopileatus and P. flabellatus), Pseudozyma (e.g., P. aphidis), Rhizopus, Rhodotorula (e.g., R. bogoriensis); Saccharomyces (e.g., S. cerevisiae, S. boulardii, S. torula), Starmerella (e.g., S. bombicola), Torulopsis, Thraustochytrium, Trichoderma (e.g., T. reesei, T. harzianum, T. viride), Ustilago (e.g., U. maydis), Wickerhamiella (e.g., W. domericqiae), Wickerhamomyces (e.g., W. anomalus), Williopsis (e.g., W. mrakii), Zygosaccharomyces (e.g., Z. bailiff), and others.

In one embodiment, yeast(s) are, for example, Wickerhamomyces anomalus, a Saccharomyces spp. yeast (e.g., S. cerevisiae and/or S. boulardii), Starmerella bombicola, Meyerozyma guilliermondii, Pichia occidentalis, and/or Pseudozyma aphidis. The yeast(s) can be in the form of live or inactive cells or spores, as well as in the form of a dried cell mass and/or dormant cells (e.g., a yeast hydrolysate).

In certain specific embodiments, the microorganism is Starmerella bombicola, which is an effective producer of sophorolipid biosurfactants. In some embodiments, the sophorolipids are produced as a mixture of acidic (linear) form sophorolipids and lactonic form sophorolipids.

In certain specific embodiments, the microorganism is Wickerhamomyces anomalus, which is an effective producer of phospholipid biosurfactants. W. anomalus also produces phytase, an enzyme useful for improved digestion and bioavailability of phosphorus from ingested food, as well as killer toxins (e.g., exo-β-1,3-glucanase) useful for controlling pathogenic microorganisms without causing harm to animals.

In some embodiments, the presence of yeast cell biomass further provides a number of proteins (containing up to 50% of dry cell biomass), lipids and carbon sources, as well as a full spectrum of minerals and vitamins (B1; B2; B3 (PP); B5; B7 (H); B6; E).

In certain embodiments, the composition comprises beneficial bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquefaciens, B. firmus, B. laterosporus, B. licheniformis, B. megaterium, Bacillus mucilaginosus, B. subtilis), Frateuria (e.g., F. aurantia), Microbacterium (e.g., M. laevaniformans), Pantoea (e.g., P. agglomerans), Pseudomonas (e.g., P. aeruginosa, P. chlororaphis, P. chlororoaphis subsp. aureofaciens (Kluyver), P. putida), Rhizobium spp., Rhodospirillum (e.g., R. rubrum), and/or Sphingomonas (e.g., S. paucimobilis).

In one embodiment, the composition comprises one or more Bacillus spp. bacteria in the form of spores and/or a dried cell mass. In certain embodiments, the Bacillus spp. are B. amyloliquefaciens, B. subtilis and/or B. licheniformis.

In some embodiments, B. amyloliquefaciens can serve as a probiotic, to increase body weight gain, increase feed intake and conversion, and increase growth hormone (e.g., GH/IGH-1) levels. Additionally, B. amyloliquefaciens can promote the growth of other beneficial microbes (e.g., producers of short chain fatty acids) while decreasing the amount of potential pathogenic microbes in an animal's gut, e.g., by producing anti-microbial lipopeptide biosurfactants. In some embodiments, a dosage of 4×10¹⁰ CFU/day of B. amyloliquefaciens is administered to an animal as part of a composition of the subject invention.

In one embodiment, the microorganism is a strain of B. subtilis, such as, for example, B. subtilis var. lotuses B1 or B2, which are effective producers of, for example, surfactin and other lipopeptide biosurfactants. This specification incorporates by reference International Publication No. WO 2017/044953 A1 to the extent it is consistent with the teachings disclosed herein.

Other microbial strains including strains capable of accumulating significant amounts of, for example, glycolipids, lipopeptides, mannoprotein, beta-glucan, enzymes, and other metabolites that have anti-methanogenic, and/or bio-emulsifying and surface/interfacial tension-reducing properties, can be used in accordance with the subject invention.

In one specific embodiment, the composition comprises about 1×10⁶ to about 1×10¹³, about 1×10⁷ to about 1×10¹², about 1×10⁸ to about 1×10¹¹, or about 1×10⁹ to about 1×10¹⁰ CFU/ml of each species of microorganism present in the composition.

In one embodiment, the composition comprises about 1 to 100% microorganisms total by volume, about 10 to 90%, or about 20 to 75%.

In one embodiment, the one or more microbial growth by-products of the subject composition is a biosurfactant. Biosurfactants are a structurally diverse group of surface-active substances produced by microorganisms, which are biodegradable and can be efficiently produced using selected organisms on renewable substrates. All biosurfactants are amphiphiles. They consist of two parts: a polar (hydrophilic) moiety and non-polar (hydrophobic) group. Due to their amphiphilic structure, biosurfactants increase the surface area of hydrophobic water-insoluble substances, increase the water bioavailability of such substances, and change the properties of bacterial cell surfaces.

Biosurfactants accumulate at interfaces, thus reducing interfacial tension and leading to the formation of aggregated micellar structures in solution. Safe, effective microbial biosurfactants reduce the surface and interfacial tensions between the molecules of liquids, solids, and gases. The ability of biosurfactants to form pores and destabilize biological membranes permits their use as antibacterial, antifungal, and hemolytic agents. Combined with the characteristics of low toxicity and biodegradability, biosurfactants are advantageous for use in pet foods and pet food supplements.

Biosurfactants include, for example, glycolipids, lipopeptides, flavolipids, phospholipids, fatty acid esters, lipoproteins, lipopolysaccharide-protein complexes, and polysaccharide-protein-fatty acid complexes. The common lipophilic moiety of a biosurfactant molecule is the hydrocarbon chain of a fatty acid, whereas the hydrophilic part is formed by ester or alcohol groups of neutral lipids, by the carboxylate group of fatty acids or amino acids (or peptides), organic acid in the case of flavolipids, or, in the case of glycolipids, by a carbohydrate.

Microbial biosurfactants are produced by a variety of microorganisms such as bacteria, fungi, and yeasts in response to the presence of a hydrocarbon source (e.g., oils, sugar, glycerol, etc.) in the growing media. The biosurfactants may be obtained by fermentation processes known in the art.

In one embodiment, the biosurfactant is a glycolipid (e.g., sophorolipids, rhamnolipids, mannosylerythritol lipids, cellobiose lipids and trehalose lipids), a lipopeptide (e.g., surfactin, iturin, fengycin, arthrofactin and lichenysin), a phospholipid (e.g., cardiolipin) or a fatty acid ester (e.g., a fatty acid methyl ester and/or fatty acid ethyl ester).

In one embodiment, the composition comprises synthetic or biologically produced amino acids. In a specific embodiment, the amino acid is valine. Valine is an amino acid produced by Wickerhamomyces anomalus and Saccharomyces spp., which helps support the growth and health of livestock animals, and enables more complete transformation of protein sources in feed. In one embodiment, the composition comprises valine in purified form, either with or without a yeast that produces it.

In certain embodiments, the compositions of the subject invention can comprise the fermentation medium in which the microorganism and/or the growth by-product was produced. Advantageously, in certain embodiments, this can make the composition superior to, for example, purified microbial metabolites alone, due to, for example, high concentrations of mannoprotein and the biopolymer beta-glucan as a part of a yeast cell wall's outer surface. These compounds can serve as, for example, effective emulsifiers. Additionally, the composition can further comprise residual biosurfactants in the culture, as well as other metabolites and/or cellular components, such as solvents, acids, vitamins, minerals, enzymes and proteins. Thus, the compositions can, among many other uses, act as surfactants and can have antimicrobial and surface/interfacial tension-reducing properties.

In one embodiment, the biosurfactant has been purified from the fermentation medium in which it was produced. Alternatively, in one embodiment, the biosurfactant is utilized in crude form. Crude form biosurfactants can take the form of, for example, a liquid mixture comprising biosurfactant sediment in fermentation broth resulting from cultivation of a biosurfactant-producing microbe. This crude form biosurfactant solution can comprise from about 0.001% to 99%, from about 25% to about 75%, from about 30% to about 70%, from about 35% to about 65%, from about 40% to about 60%, from about 45% to about 55%, or about 50% pure biosurfactant.

In certain embodiments, the biosurfactant can be added to the composition in the form of a microbial culture containing liquid fermentation broth and cells resulting from submerged cultivation of a biosurfactant-producing microbe. In a specific embodiment, when the biosurfactant is a sophorolipid, this “culture form” biosurfactant can comprise fermentation broth with Starmerella bombicola yeast cells, sophorolipids (SLP), and other yeast growth by-products therein. The yeast cells may be active or inactive at the time they are contacted with or formulated with animal food. If a lower concentration of SLP is desired, the SLP portion that results in the S. bombicola culture can be removed, and the residual liquid having, for example, 1-4 g/L residual SLP and, optionally, yeast cells and other growth by-products can be utilized in the subject methods. When use of another biosurfactant is desired, a similar product is envisioned that utilizes any other microbe capable of producing the other biosurfactant.

In one embodiment, the composition can further comprise water. For example, the microorganism and/or growth by-products can be mixed with an animal's drinking water as, for example, a feed additive and/or supplement.

In one embodiment, the composition can further comprise pre-made raw or cooked wet or dry pet or animal food, wherein the pre-made food has been processed to be ready for animal consumption. For example, the microorganism and/or growth by-products can be poured onto and/or mixed with the pre-made raw or cooked food, or the microorganism and/or growth by-products can serve as a coating on the outside of dry animal food pieces, e.g., kibbles, pellets, treats and/or biscuits.

In one embodiment, the composition can further comprise raw ingredients for making cooked pet and animal food, wherein the raw ingredients, together with the microorganism and/or growth by-products, are then cooked and/or processed to make an enhanced dry or wet pet food product.

In one embodiment, the subject composition can comprise additional nutrients to supplement an animal's diet and/or promote health and/or well-being in the animal, such as, for example, sources of amino acids (including essential amino acids), peptides, proteins, vitamins, microelements, fats, fatty acids, lipids, carbohydrates, sterols, enzymes, and trace minerals such as, iron, copper, zinc, manganese, cobalt, iodine, selenium, molybdenum, nickel, fluorine, vanadium, tin and silicon.

Preferred compositions comprise vitamins and/or minerals in any combination. Vitamins for use in a composition of this invention can include for example, vitamins A, E, K3, D3, B1, B3, B6, B12, C, biotin, folic acid, panthothenic acid, nicotinic acid, choline chloride, inositol and para-amino-benzoic acid. Minerals can include, for example, salts of calcium, cobalt, copper, iron, magnesium, phosphorus, potassium, selenium and zinc. Other components may include, but are not limited to, antioxidants, beta-glucans, bile salt, cholesterol, enzymes, carotenoids, and many others. Typical vitamins and minerals are those, for example, recommended for daily consumption and in the recommended daily amount (RDA), although precise amounts can vary. The composition would preferably include a complex of the RDA vitamins, minerals and trace minerals as well as those nutrients that have no established RDA, but have a beneficial role in healthy animal physiology.

### Production of Microorganisms and/or Microbial Growth By-Products

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites, residual nutrients and/or intracellular components.

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In one embodiment, one or more biostimulants may also be included, meaning substances that enhance the rate of growth of a microorganism. Biostimulants may be species-specific or may enhance the rate of growth of a variety of species.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam when gas is produced during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The biomass content of the fermentation medium may be, for example, from 5 g/l to 180 g/l or more, or from 10 g/l to 150 g/l. The cell concentration may be, for example, at least 1×10⁹, 1×10¹⁰, 1×10¹¹, 1×10¹² or 1×10¹³ cells per gram of final product.

The microbial growth by-product produced by microorganisms of interest may be retained in the microorganisms or secreted into the growth medium. The medium may contain compounds that stabilize the activity of microbial growth by-product.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

### Preparation of Microbe-Based Products

The subject invention provides microbe-based products for use in feeding domesticated animals. One microbe-based product of the subject invention is simply the fermentation medium containing the microorganism and/or the microbial metabolites produced by the microorganism and/or any residual nutrients. The product of fermentation may be used directly without extraction or purification. If desired, extraction and purification can be easily achieved using standard extraction and/or purification methods or techniques described in the literature.

In one embodiment, a yeast fermentation product, designated as “Star 3+,” can be obtained via cultivation of the killer yeast, Wickerhamomyces anomalus, using a modified form of solid state fermentation. The culture can be grown on a substrate with ample surface area onto which the yeasts can attach and propagate, such as, for example, rice, soybeans, chickpeas, pasta, oatmeal or beans. The entire fermentation medium with yeast cells growing throughout, can be harvested after, for example, 3-5 days of cultivation at 25-30° C. The culture can be blended with the substrate, milled and/or micronized, and optionally, dried. This comprises the Star 3+product. The composition, which can comprise about 1×10⁸ to 1×10¹², or about 1×10¹⁰ CFU/gram, can be diluted, for example, 500 to 1,000 times prior to being mixed with other components.

In an alternative embodiment, the yeast fermentation product is obtained using submerged fermentation, wherein the yeast fermentation product comprises liquid broth comprising cells and any yeast growth by-products. A liquid medium containing necessary sources of carbon, nitrogen, minerals and optionally, antimicrobial substances to prevent contaminating bacterial growth can be used. The culture can be grown with an additional carbon source, particularly, a saturated oil (e.g., 15% canola oil, or used cooking vegetable oil). Typically, the pH begins at 5.0-5.5, then decreases to 3.0-3.5, where it is stabilized. The fermentation broth with cells and yeast growth by-products, which can be harvested after, for example, 24-72 hours of cultivation at 25-30° C., comprises this alternative form of the Star 3+ product.

In one embodiment, a yeast fermentation product can be obtained via submerged cultivation of the biosurfactant-producing yeast, Starmerella bombicola. This yeast is an effective producer of glycolipid biosurfactants, such as sophorolipids (SLP). The fermentation broth after 5 days of cultivation at 25° C. can contain the yeast cell suspension and, for example, 150 g/L or more of SLP. This yeast fermentation product can be further modified if less biosurfactant is desired in the composition. For example, fermentation of S. bombicola results in precipitation of the SLP into a distinguishable layer. This SLP layer can be removed and the residual liquid and biomass, which can still contain 1-4 g/L of residual SLP, can then be utilized in the subject composition.

The microorganisms in the microbe-based product may be in an active or inactive form. Furthermore, the microorganisms may be removed from the composition, and the residual culture utilized. The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

The microbes and/or medium (e.g., broth or solid substrate) resulting from the microbial growth can be removed from the growth vessel and transferred via, for example, piping for immediate use.

In one embodiment, the microbe-based product is simply the growth by-products of the microorganism. For example, biosurfactants produced by a microorganism can be collected from a submerged fermentation vessel in crude form, comprising, for example about 0.001% to 99% pure biosurfactant in liquid broth.

In other embodiments, the microbe-based product (microbes, medium, or microbes and medium) can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 gallon to 1,000 gallons or more. In other embodiments the containers are 2 gallons, 5 gallons, 25 gallons, or larger.

Upon harvesting, for example, the yeast fermentation product, from the growth vessels, further components can be added as the harvested product is placed into containers and/or piped (or otherwise transported for use). The additives can be, for example, buffers, carriers, other microbe-based compositions produced at the same or different facility, viscosity modifiers, preservatives, nutrients for microbe growth, tracking agents, solvents, biocides, other microbes and other ingredients specific for an intended use.

Other suitable additives, which may be contained in the formulations according to the invention, include substances that are customarily used for such preparations. Examples of such additives include surfactants, emulsifying agents, lubricants, buffering agents, solubility controlling agents, pH adjusting agents, preservatives, stabilizers and ultra-violet light resistant agents.

In one embodiment, the product may further comprise buffering agents including organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt such as sodium bicarbonate or carbonate, sodium sulfate, sodium phosphate, sodium biphosphate, can be included in the formulation.

Advantageously, in accordance with the subject invention, the microbe-based product may comprise broth in which the microbes were grown. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### Methods for Feeding Animals

In preferred embodiments, the subject invention provides a method for feeding domesticated animals which comprises a microorganism and/or a growth by-product thereof is contacted with an animal's food and/or drinking water, prior to the animal ingesting the food and/or water. Advantageously, the methods can be useful for providing a nutrient to an animal, as well as for enhancing the digestive (GI) health, dental/oral cavity health, and immune health of an animal. Furthermore, the subject composition can serve as a preservative by prolonging the shelf life of pet food and preventing contamination of the pet food by undesirable microorganisms.

In one embodiment, the composition is used either as a liquid or a dried product. In one embodiment the composition is introduced, either in the liquid or dried form, into an animal's food, or into the animal's drinking water. In one embodiment, the composition is added to a chew toy or bone.

In one embodiment, the composition is added to standard raw food ingredients utilized in producing raw animal food, wet food and/or dry food, such as meat products, grains, vegetables, fruits, and other flavorings, additives and/or sources of nutrients. The raw ingredients and the composition can then be cooked and/or processed according to standard procedures for producing pet and/or animal feed.

As used herein, “raw food” refers to pet food that is meant to be consumed uncooked. Raw dog food, for example, often comprises uncooked meat, whole or crushed bones, fruits, vegetables, eggs and/or dairy.

As used herein, “dry food” refers to pet food that is of a similar composition to wet food but contains a limited moisture content typically in the range of about 5% to about 15% or 20% w/v (typically in the form of small to medium sized individual pieces, e.g., kibbles, treats, biscuits, or pellets). In one embodiment, the compositions have moisture content from about 5% to about 20% w/v. Dry food products include a variety of foods of various moisture contents, such that they are relatively shelf-stable and resistant to microbial or fungal deterioration or contamination.

In one embodiment, the composition can be added to the raw ingredients utilized in producing dry food. The supplemented dry food pieces can comprise consistent concentrations of the microbe-based composition per piece. In another embodiment, the composition can be utilized as a surface coating on the dry food pieces. Methods known in the art for producing dry foods can be used, including pressurized milling, extrusion, and/or pelleting.

In an exemplary embodiment, dry food may be prepared by, e.g., screw extrusion, which includes cooking, shaping and cutting raw ingredients into a specific kibble shape and size in a very short period of time. The ingredients may be mixed into homogenous expandable dough and cooked in an extruder, and forced through a die under pressure and high heat. After cooking, the kibbles are then allowed to cool, before optionally being sprayed with a coating. This coating may comprise, for example, liquid fat or digest, including liquid or powdered hydrolyzed forms of an animal tissue such as liver or intestine from, e.g., chicken or rabbit, and/or a nutritional oil. In other embodiments, the kibble is coated using a vacuum enrobing technique, wherein the kibble is subjected to vacuum and then exposed to coating materials after which the release of the vacuum drives the coating materials inside the kibble. Hot air drying can then be employed to reduce the total moisture content to 10% or less.

In one embodiment, the dry food is produced using a “cold” pelleting process, or a process that does not use high heat or steam. The process can use, for example, liquid binders with viscous and cohesive properties to hold the ingredients together without risk of denaturing or degrading important components and/or nutrients in the compositions of the subject invention.

In an exemplary embodiment, canned (wet) food may be prepared, e.g., by blending the raw ingredients including meats and vegetables, gelling agents, gravies, vitamins, minerals and water. The mix is then fed into cans on a production line, the lids are sealed on and the filled cans are sterilized at a temperature of about 130° C. for about 50 to 100 min. As used herein, “wet food” refers to pet food that is typically sold in cans or foil bags and has a moisture content typically in the range of about 70% to about 90% w/v.

In one embodiment, the composition may be prepared as a spray-dried biomass product. The biomass may be separated by known methods, such as centrifugation, filtration, separation, decanting, a combination of separation and decanting, ultrafiltration or microfiltration.

In one embodiment, the composition has a high nutritional content. As a result, the composition may be used as part of all of a complete animal feed composition. In one embodiment, the feed composition comprises the subject composition ranging from 15% of the feed to 100% of the feed.

The subject compositions may be rich in at least one or more of fats, fatty acids, lipids such as phospholipid, vitamins, essential amino acids, peptides, proteins, carbohydrates, sterols, enzymes, and trace minerals such as, iron, copper, zinc, manganese, cobalt, iodine, selenium, molybdenum, nickel, fluorine, vanadium, tin and silicon.

Additionally, due to the antimicrobial properties of the composition, the methods can enhance the immune health of an animal while reducing the need for antibiotics. In one embodiment, the methods can reduce the occurrence or severity of infections in the GI tract by controlling infectious microorganisms therein. In another embodiment, the methods can reduce the occurrence or severity of conditions of the oral cavity. For example, through the oral ingestion of the subject compositions, control of microorganisms in the oral cavity that cause halitosis and tooth decay can be achieved, and the development of periodontal disease can be delayed and/or minimized.

Furthermore, in one embodiment, the subject methods can help prolong the shelf life of pet food and/or prevent contamination by undesirable microorganisms, such as food borne pathogens, without the need for harmful chemical preservatives.

In some embodiments, the compositions described herein can be used as a dietary supplement and be co-administered with another pet food composition. The dietary supplement can have any suitable form such as a gravy, drinking water, beverage, yogurt, powder, granule, paste, suspension, chew, morsel, liquid solution, treat, snack, pellet, pill, capsule, tablet, sachet, or any other suitable delivery form. The dietary supplement can comprise the subject microbe-based compositions, as well as optional compounds such as vitamins, minerals, probiotics, prebiotics, and antioxidants. In some embodiments, the dietary supplement may be admixed with a pet food composition or with water or other diluent prior to administration to the animal.

Advantageously, due to the presence of, for example, biosurfactants in the subject compositions, the methods can enhance nutrient and/or water absorption through the epithelial cells of the animal's digestive tract by increasing the bioavailability of a nutrient and/or of water present in, for example, pet food or dietary supplements.

In one embodiment, the nutrient is a fat and/or an amino acid. Fats serve as a source of fatty acids for energy (especially for heart and skeletal muscles), and amino acids serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the pet food products, although carbohydrates are not a superior energy source for pet over protein or fat.

Fats are typically provided via incorporation of fish meals (which contain a minor amount of fish oil) and fish oils into the pet food products. Extracted oils that may be used in pet food products include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids, EPA and DHA; in contrast, vegetable oils do not provide a source of EPA and/or DHA. A typical pet food product will comprise from about 15-30% of oil (e.g., fish, vegetable, etc.), measured as a weight percent of the pet food product.

In one embodiment, the nutrient is a protein. Protein supplied in pet food products can be of plant or animal origin. For example, protein of animal origin can be from marine animals (e.g., fish oil, pet protein, krill meal, mussel meal, shrimp peel, squid meal, squid oil, etc.) or land animals (e.g., blood meal, egg powder, liver, kidney, meat and bone meal, silkworm, pupae meal, whey powder, etc.). Protein of plant origin can include soybean meal, corn gluten meal, wheat gluten, cottonseed meal, canola meal, sunflower meal, rice and the like.

In one embodiment, the nutrient is a vitamin or a trace mineral. Vitamins can include, for example, vitamins A, E, K3, D3, B1, B3, B6, B12, C, biotin, folic acid, panthothenic acid, nicotinic acid, choline chloride, inositol and para-amino-benzoic acid. Minerals can include, for example, salts of calcium, cobalt, copper, iron, magnesium, phosphorus, potassium, selenium and zinc. Other components may include, but are not limited to, antioxidants, beta-glucans, bile salt, cholesterol, enzymes, carotenoids, and many others.

According to the methods of the subject invention, administration of the microbe-based compositions can be performed as part of a dietary regimen, which can span a period ranging from parturition through the adult life of the animal. In certain embodiments, the animal is a young or growing animal. In some embodiments, the animal is an aging animal. In other embodiments administration begins, for example, on a regular or extended regular basis, when the animal has reached more than about 30%, 40%, 50% , 60%, or 80% of its projected or anticipated lifespan.

The compositions described herein are administered to an animal via the animal's food and/or drinking water, for a time required to accomplish one or more objectives of the invention, such as, promoting and/or enhancing the immune health of the animal (through, e.g., control of infection); promoting and/or enhancing the digestive health of the animal; providing a nutrient to the animal; enhancing hydration of the animal; promoting dental health and/or health of the oral cavity (through, e.g., control of bacteria that cause tooth decay, halitosis, and periodontal disease); and overall, improving the quality of life and promoting the health and wellness in an animal. In some embodiments, the compositions described herein are contacted with an animal's food and/or drinking water on a regular basis, e.g., at every meal, or one meal per day.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1

### Production of Sophorolipids

The fermentation temperature is generally between about 22-28° C., depending on the microorganism and/or microbial growth by-product being cultivated. For Starmerella bombicola, a temperature of about 25° C. is ideal.

The pH should be from about 2.0 to about 7.0, and preferably between about 3.0 to about 6.5, depending on the microorganism and/or microbial growth by-product being cultivated. Additionally, in order to reduce the possibility of contamination, the cultivation process can begin at a first pH range and then be adjusted to a second pH range either higher or lower than the first pH range.

Under these cultivation conditions, industrially useful production of biomass, biosurfactants and other metabolites are achieved after as little as 24 hours of fermentation. Upon completion of the fermentation, the growth by-products and/or leftover culture can then be harvested from the reactors and applied for a variety of industrial purposes.

The reactors can then be sterilized again and re-used for fermenting either the same microbe-based products or different microbe-based products. For example, the reactors can be used to cultivate Starmerella bombicola for production of SLP, then sterilized according to the subject methods, and then used to produce SLP again, or to cultivate Pseudozyma aphidis for production of MELs.

The subject systems can be used to produce sophorolipids (SLP) on an industrial scale and without contamination of the production culture.

In one embodiment, the reactor is inoculated with Starmerella bombicola yeast. The culture medium comprises a carbon source, a lipid, a nitrogen source, and can be supplemented with up to 200 ppm pure sophorolipid.

The yeast and culture medium are incubated at pH 3.0-3.5 under aerobic conditions and for a period of time sufficient for initial accumulation of biomass (typically about 24 hours to about 48 hours). The temperature is held at 22° to 28° C. and dissolved oxygen concentration is held within 15% to 30% (of 100% ambient air). Once initial biomass accumulation is achieved, pH is adjusted to 5.5 and the process continued.

When the culture acidifies to pH 3.5, the fermentation process continues, keeping the pH stable at this level until sufficient accumulation of SLP is achieved in the medium. The SLP forms a brown-colored translucent to opaque sediment layer in the medium. The SLP is then recovered from the fermentation medium, and the leftover yeast fermentation product can be harvested separately.

1. A method for feeding a domesticated animal, wherein a composition comprising a biosurfactant-producing microorganism and/or a growth by-product thereof, is formulated into the animal's food and/or drinking water prior to the animal ingesting the food and/or drinking water.

2. The method of claim 1, wherein the growth by-product is a biosurfactant.

3. The method of claim 2, wherein the biosurfactant is a glycolipid selected from sophorolipids, rhamnolipids, mannosylerythritol lipids, cellobiose lipids and trehalose lipids.

4. The method of claim 2, wherein the biosurfactant is a lipopeptide selected from surfactin, iturin, fengycin, arthrofactin and lichenysin.

5. The method of claim 2, wherein the biosurfactant is a phospholipid.

6. (canceled)

7. The method of claim 2, wherein the biosurfactant is in crude form, said crude form comprising the biosurfactant in fermentation broth in which a biosurfactant-producing microorganism was cultivated.

8-11. (canceled)

12. The method of claim 1, wherein the animal's food or water contains a nutrient for promoting the animal's health and/or well-being, and wherein the bioavailability of the nutrient to the animal's digestive tract is enhanced by the composition that has been formulated into the food or water.

13. A method for prolonging the shelf-life of pet food, wherein a composition comprising a biosurfactant-producing microorganism and/or a microbial growth by-product thereof, is formulated into the pet food.

14. (canceled)

15. A composition for feeding a domesticated animal, the composition comprising a biosurfactant-producing microorganism and/or a growth by-product thereof, wherein the growth by-product is a biosurfactant.

16. The composition of claim 15, wherein the biosurfactant is a glycolipid selected from sophorolipids, rhamnolipids, mannosylerythritol lipids, cellobiose lipids and trehalose lipids.

17. The composition of claim 15, wherein the biosurfactant is a lipopeptide selected from surfactin, iturin, fengycin, arthrofactin and lichenysin.

18. The composition of claim 15, wherein the biosurfactant is a phospholipid.

19. (canceled)

20. The composition of claim 15, wherein the biosurfactant is in crude form, said crude form comprising the biosurfactant in fermentation broth in which a biosurfactant-producing microorganism was cultivated.

21. The composition of claim 20, comprising the crude form biosurfactant without the microorganism that produced it.

22. The composition of claim 15, further comprising water, wherein the water is an animal's drinking water.

23-26. (canceled)

27. The composition of claim 15, further comprising one or more nutrients for animal health.

28. The composition of claim 27, wherein the one or more nutrients are selected sources of amino acids, peptides, proteins, vitamins, microelements, fats, fatty acids, lipids, carbohydrates, sterols, enzymes, and trace minerals.
